(19) United States
(12) Patent Application Publication
(10) Pub. No.: US 2012/0221404 A1
(43) Pub. Date: Aug. 30, 2012

(54) METHOD AND APPARATUS FOR PROVIDING AN ADVERTISING PLATFORM

(75) Inventors: Zahid N. Ahmed, Westborough, MA (US); Catalin Horatiu Roman, Baciu (RO); Mihai-Robert Enyedi, Cluj-Napoca (RO); Laurent Chollat, Espoo (FI)

(73) Assignee: Nokia Corporation, Espoo (FI)

(21) Appl. No.: 13/073,479

(22) Filed: Mar. 28, 2011

Related U.S. Application Data
(60) Provisional application No. 61/446,632, filed on Feb. 25, 2011.

(51) Int. Cl. G06Q 30/00

(52) U.S. Cl. 705/14.39; 705/14.64; 705/14.53

(57) ABSTRACT

An approach is provided for providing an advertising platform. The advertising platform determines an initiation of a location-based search at a device, and one or more results of the location-based search. The one or more results include at least one listing for at least one merchant. The advertising platform then processes and/or facilitates a processing of the one or more results to determine one or more advertisements associated with the at least one merchant for presentation at the device. The advertising platform then causes, at least in part, tracking of user interaction information in response to the presentation of the one or more advertisements. The advertising platform further determines user characteristic information associated with a plurality of users of at least one application, and then processes and/or facilitates a processing of the user characteristic information to determine at least one recommended value to request for presenting one or more advertisements via the at least one application.

### RELATED APPLICATIONS

This application claims the benefit of the earlier filing date under 35 U.S.C. §119(e) of U.S. Provisional Application Ser. No. 61/446,632 filed Feb. 25, 2011, entitled “Method and Apparatus for Providing an Advertising Platform,” the entirety of which is incorporated herein by reference.

### BACKGROUND

Service providers and device manufacturers (e.g., wireless, cellular, etc.) are continually challenged to deliver value and convenience to consumers by, for example, providing compelling network services. These network services may generate revenue from the network services by presenting advertisements to users of the services. Examples of network services include messaging services, maps and navigation services, social networking services, media services, purchasing services, gaming services, and the like. Advertisements can be positioned in the same screen as an active service presented to a user and/or as in a separate view before, after, or during the use of the service. Typically an advertiser will agree with an ad network to initiate an advertisement campaign. The campaign may be initiated through an automated system such as a self serve interface to an advertisement server, or by meeting and signing a contract. The advertisement campaign may include a number of parameters such as an impression target, number of unique user to be reached, frequency capping, etc. An advertising campaign may be made of different advertising flights each having possibly different validity times and targeted publishers or users. For example, an advertising flight contains at least one advertising creative (e.g. a banner, a text, etc.), but may also contain a more creatives (e.g., thousands of creatives). Although advertisements used in conjunction with these services have become increasingly popular, device manufacturers and service providers face significant technical challenges to increasing the effectiveness of advertisements and tailoring the advertisements to the needs and/or interests of, for instance, consumers, advertisers, and service providers (e.g., application publishers, application developers, etc.).

### SOME EXAMPLE EMBODIMENTS

Therefore, there is a need for an approach for providing an advertising platform.

According to one embodiment, a method comprises determining an initiation of a location-based search at a device. The method also comprises determining one or more results of the location-based search, the one or more results including at least one listing for at least one merchant. The method further comprises processing and/or facilitating a processing of the one or more results to determine one or more advertisements associated with the at least one merchant for presentation at the device. The method further comprises causing, at least in part, tracking of user interaction information in response to the presentation of the one or more advertisements.

According to another embodiment, an apparatus comprising at least one processor, and at least one memory including computer program code, the at least one memory and the computer program code configured to, with the at least one processor, cause, at least in part, the apparatus to determine an initiation of a location-based search at a device. The apparatus is also caused to determine one or more results of the location-based search, the one or more results including at least one listing for at least one merchant. The apparatus is further caused to process and/or facilitate a processing of the one or more results to determine one or more advertisements associated with the at least one merchant for presentation at the device. The method further causes, at least in part, tracking of user interaction information in response to the presentation of the one or more advertisements.

According to another embodiment, a computer-readable storage medium carrying one or more sequences of one or more instructions which, when executed by one or more processors, cause, at least in part, an apparatus to determine an initiation of a location-based search at a device. The apparatus is also caused to determine one or more results of the location-based search, the one or more results including at least one listing for at least one merchant. The apparatus is further caused to process and/or facilitate a processing of the one or more results to determine one or more advertisements associated with the at least one merchant for presentation at the device. The method further causes, at least in part, tracking of user interaction information in response to the presentation of the one or more advertisements.

According to another embodiment, an apparatus comprises means for determining an initiation of a location-based search at a device. The apparatus also comprises means for determining one or more results of the location-based search, the one or more results including at least one listing for at least one merchant. The apparatus further comprises means for processing and/or facilitating a processing of the one or more results to determine one or more advertisements associated with the at least one merchant for presentation at the device. The apparatus further comprises means for causing, at least in part, tracking of user interaction information in response to the presentation of the one or more advertisements.

According to another embodiment, a method comprises determining user characteristic information associated with a plurality of users of at least one application. The method also comprises processing and/or facilitating a processing of the user characteristic information to determine at least one recommended value to request for presenting one or more advertisements via the at least one application.

According to another embodiment, an apparatus comprising at least one processor, and at least one memory including computer program code, the at least one memory and the computer program code configured to, with the at least one processor, cause, at least in part, the apparatus to determine user characteristic information associated with a plurality of users of at least one application. The apparatus is also caused to process and/or facilitate a processing of the user characteristic information to determine at least one recommended value to request for presenting one or more advertisements via the at least one application.

According to another embodiment, a computer-readable storage medium carrying one or more sequences of one or more instructions which, when executed by one or more processors, cause, at least in part, an apparatus to determine user characteristic information associated with a plurality of users of at least one application. The apparatus is also caused to process and/or facilitate a processing of the user characteristic information to determine at least one recommended value to request for presenting one or more advertisements via the at least one application.

According to another embodiment, an apparatus comprises means for determining user characteristic information associated with a plurality of users of at least one application. The apparatus also comprises means for processing and/or facilitating a processing of the user characteristic information to determine at least one recommended value to request for presenting one or more advertisements via the at least one application.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing an advertising platform, according to one embodiment;

FIG. 2A is a diagram of the components of an advertising platform, according to one embodiment;

FIG. 2B is a diagram of the components of an advertisement enabler, according to one embodiment;

FIG. 3 is a flowchart of providing advertisements to a location-based search via the advertising platform, according to one embodiment;

FIG. 4 is a flowchart of a sample use case for providing advertisements to a location-based search, according to one embodiment;

FIG. 5 is a flowchart of a process for managing advertisements and inventory for presenting the advertisements, according to one embodiment;

FIG. 6 is a diagram of a user interface for location-based targeted advertising, according to one embodiment;

FIGS. 7A-7C are diagrams of user interfaces for targeted advertising based on user interaction, according to various embodiments;

FIG. 8 is a diagram of user interfaces for managing advertisements and inventory for presenting the advertisements, according to one embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for providing an advertising platform are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

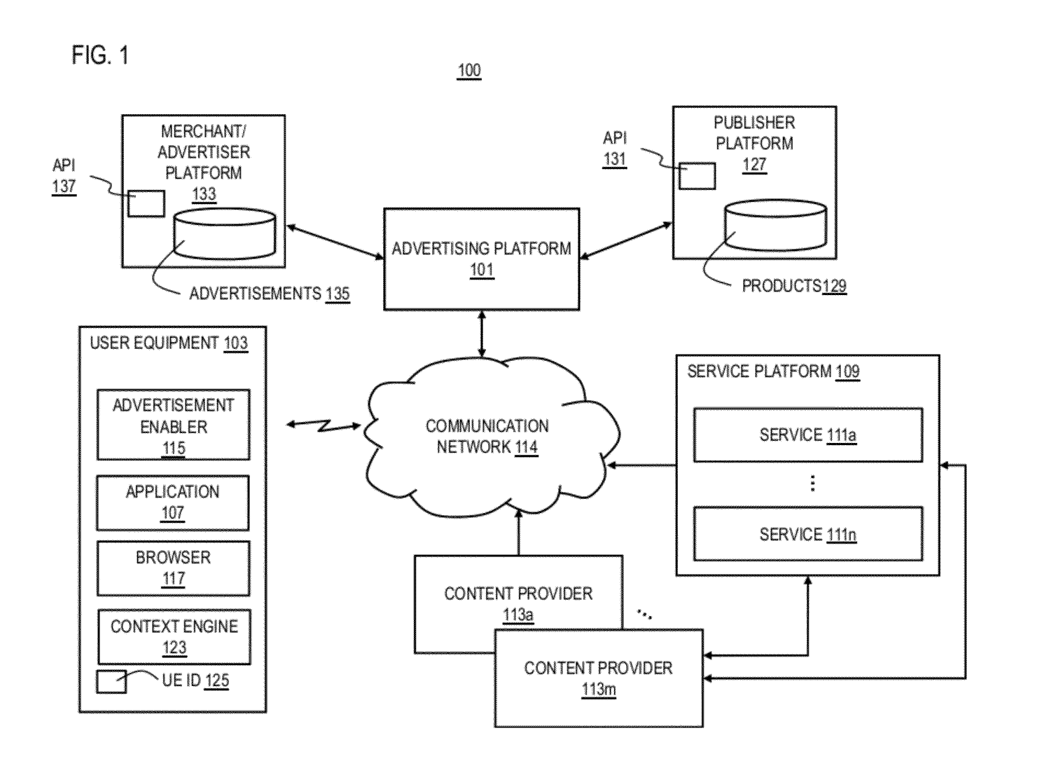

FIG. 1 is a diagram of a system capable of providing an advertising platform, according to one embodiment. As noted previously, service providers and device manufacturers may generate revenue or otherwise promote additional services, features, products, etc. by presenting advertisements on user devices. Advertisements generally may be presented in association with various applications and/or services such as messaging, navigation, maps, social networking, media (e.g., video, audio, images, etc.), games, stores, etc. For example, a messaging application may display, in a portion of a graphical user interface, the advertisement in parallel with presenting the messaging features.

In one embodiment, advertisements to be displayed to users of devices can be retrieved from an advertising server, stored in a cache of the device, and presented to the user. Advertising engines or advertising enablers can retrieve advertisements from the cache to present advertisements with one or more applications. In certain embodiments, an advertising engine is a program and/or hardware resident on a device that can retrieve advertisements from the advertising server and control presentation of the advertisements. The advertising engine can fetch advertisements from an advertising server or platform via an Application Programming Interface (API) to store in the cache for presentation via, for instance, the applications. Further, the advertising engine can provide an API for applications running the advertising engine to request advertisements to present.

Advertisers generally have a target audience (e.g., based on demographics) for their advertising campaigns. By way of example, the advertisements can then be provided to specific users who are members of one or more of the target demographics. In certain embodiments, demographics are characteristics of a population. Examples of demographics include age, sex, race, disabilities, mobility, education, home ownership, employment status (e.g., employed, underemployed, unemployed, etc.), location (e.g., urban, suburban, rural, etc.), income level (e.g., middle-class, upper-class, upper-middle-class, poor, etc.), military status, family status, marriage status, vehicles owned, etc. A demographic target and/or demographic group can include one or more demographics and/or demographic ranges as parameters. For example, a demographic group may include males between the ages of 18 and 25. However, it can difficult to target these demographic groups at high certainty because it often is difficult to accurately determine what applications, context information, profile information, etc. relate to a particular target group, particularly when the primary means of interaction is via user device or applications executed on the device. Moreover, it can be difficult to associate or otherwise correlate user interactions taken in response to such advertisements, particularly when the interaction with offline merchants, advertisers, etc. where interactions records can be sparse.

To address this problem, a system 100 of FIG. 1 introduces an advertising platform 101 with the capability to integrate the selection, aggregation, delivery, etc. of advertisements and related information (e.g., discount information, coupons, offers, promotions, other marketing materials, etc.), as well as to integrate the user experience, the merchant/advertiser experience, and/or the publisher/developer experience associated with serving the advertisements (e.g., banner advertisements, location-based advertisements, in-application advertisements, event or situational advertisements, etc.) to user devices. As used herein, in one embodiment, the user refers to an entity to which the advertisement is presented (e.g., via a user equipment (UE) 103 associated with the user). Moreover, the merchant/advertiser is an entity that creates and/or requests presentation of the advertisements (e.g., as part of a marketing campaign). In one embodiment, the merchant/advertiser experience is facilitated by the merchant/advertiser platform 105, which includes, for instance, one or more portals, application programming interfaces (APIs), etc to support connectivity or access by merchants, advertisers, and the like. As used herein, the publisher/developer is, for instance, a producer, owner, licensee, or other party with the rights for controlling the means through which advertisements are presented in the system 100. By way of example, the means include applications (e.g., an application 107 executing at the UE 103), services (e.g., a service platform 109, one or more services 111a-111n of the service platform 109), content providers 113a-113m, and other similar entities. In one embodiment, the publisher/developer experience is facilitated by the publisher platform 115 which includes, for instance, one or more portals, application programming interfaces (APIs), etc to support connectivity or access by publishers, developers, content providers, and the like.

More specifically, in one embodiment, the system 100 exposes relevant interfaces (e.g., application programming interfaces (APIs)) to merchants/advertisers, publishers, etc. to target users for presentation of one or more advertisements. In one embodiment, it is contemplated that the advertising platform 101 may serve advertisements that are related to digital and/or physical goods and that the merchants/advertisers can be engaged in online commerce, offline commerce, or both. In this way, the advertising platform 101 enables the bridging of online commerce conducted via the UE 103 to offline or physical merchants.

In one embodiment, the system 100 targets users for advertisements based, at least in part, on location-based searches conducted by the users. For example, the system 100 determines when a user initiates a location-based search (e.g., a search including location as at least one criteria such as when search for nearby businesses, retailers, etc.) and serves advertisements to the user based on results (e.g., a merchant listing) of the location-based search. In one embodiment, the corresponding advertisement may be served based, on a business relationship, with the merchant matching the result. For example, the merchant may pay a fee to increase a ranking or position of the merchant's listing in the list of search results.

In another embodiment, the merchant may place location-based advertisements linked to specific places or locations that may be in the search results. For example, a user may be searching for nearby restaurants. In this case, the merchant (e.g., a restaurant) may associate advertisements with its location on map that are presented when the merchant's listing is part of the search results. Accordingly, the system 100 presents the merchant's advertisements in response to the user's search for nearby restaurants. In one embodiment, the presentation of advertisement is through one or more products (e.g., an application or service) of one or more publishers and/or developers.

In one embodiment, the system 100 continues to track and respond to subsequent user interactions with the presentation of the initial location-based advertisement. For example, the system 100 may navigate or otherwise direct the user to the merchant's place as presented in the advertisement information. If the user physically goes to the location or place, the system 100 may provide additional advertisements, promotions, marketing materials, etc. (e.g., a coupon or other discount information) for use while at the place. If the user further interacts by actually using the coupon at the merchant's location, the system 100 can track this information and provide potentially other advertisements, promotions, offers, etc. related to the merchant or other merchants.

In one embodiment, any of the information about the user experience and interactions with the advertisements can be tracked and then reported to the merchant/advertiser and/or publisher/developer. In this way, the merchants and publishers can conduct various analyses of the data to determine, for instance, the effectiveness or success of particular advertising campaigns, etc.

In yet another embodiment, the system 100 can mediate the interactions between the merchant/advertisers and the publishers/developers to recommend, for instance, the estimated values of advertisements as well as through what mechanisms to advertise. For example, it is generally the case that the amount of advertisements and the mechanisms or means for presenting those advertisements to users (e.g., through advertising space in applications) are typically unbalanced. In other words, there are typically either more advertisements than available advertising space (e.g., advertising inventory), or more inventory than advertisements. Accordingly, service providers face significant challenges to mediating the balance between merchants/advertisers and the publishers/developers who are offering advertising inventory.

To address this problem, the system 100 introduces the capability to facilitate the determination of inventory value for targeting advertisements to specific users. More specifically, the system 100 evaluates information on the user characteristics (e.g., age group, gender, application use history, other demographic information, etc.) associated with users of items (e.g., applications) in the inventory to recommend a value (e.g., a monetary value) for presenting advertisements through the item or application. From the advertisers' side, the system 100 enables merchants/advertisers to specify criteria for targeting a particular audience and then recommends potential applications and recommended values to offer for presenting advertisements through the recommended items or applications. In some embodiments, the system 100 can automatically match the available inventory against the target audience criteria to mediate the creation of advertising campaigns involving the merchants/advertisers and the publishers/developers to provide a user advertising experience.

As shown in FIG. 1, the system 100 comprises user equipment (UE) 103 having connectivity to the advertising platform 101, the service platform 109, and the content providers 113a-113m via a communication network 114. In the illustrated embodiment, the UE 103 includes an advertisement enabler 115 that provides components that enable serving of advertisements of multiple formats (e.g., banners advertisements, location-based advertisements, in-application advertisements, event or situational advertisements, etc.) via, for instance, the application 107 and/or the browser 117. In one embodiment, the application 107 is a client for at least one of the services 111a-111n of the service platform 109. In one embodiment, the application 107 is script delivered through the browser 117. In one embodiment, the advertisements and/or content files for serving the advertisements can be specified by and/or obtained from the service platform 109, the services 111a-111n of the service platform 109, the content providers 113a-113m, and/or other components such as the advertising platform 101 or the merchant/advertiser platform 133 (discussed in more detail below).

In one embodiment, the UE 103 also includes a context engine 123. The context engine 123 determines, for instance, the local context of UE 103 and any user thereof, such as local time, geographic position from a positioning system, ambient temperature, pressures, sound and light, and applications currently executing on UE 103, history of application usage, content currently being rendered on UE 103, user input through a user interface (UI), and/or other user interactions determined at the UE 103.

In one embodiment, the UE 103 also includes a data structure that stores data that indicates a UE identifier (ID) 125, such as an International Mobile Equipment Identity (IMEI) that is a number, usually unique, to identify GSM, WCDMA, iDEN and some satellite mobile phones. In one embodiment, depending on privacy settings, the UE ID 125 or other identifier can be used to uniquely identify and/or track user interactions, context, profile information, etc. associated with the user to facilitate the serving advertisements to the user.

In one embodiment, the advertisement enabler 115 enables the use of the advertising platform 101 (e.g., via an API) to present advertisements in the application 107. By way of example, the application 107 may present the advertisements in a portion of a graphical user interface (GUI) associated with the application 107. Further, the advertising platform 101 may control advertisements provided to and/or presented by the applications 107 via the advertisement enabler 115. As the advertising platform 101 is used to present advertisements, data can be collected by the advertisement enabler 115 and/or context engine 123. Such data can include, for example, whether the number of impressions of a particular advertisement and/or advertising campaign was made, the number of times the user clicked on one of the advertisements, etc.

In the illustrated embodiment, a publisher platform 127 is included for publishers/developers of products, including applications for user equipment. For example, the publisher platform 127 exposes self-service interfaces for advertisement campaign and yield optimization management to enable publishers to reach and engage users (e.g., track and respond to user interaction with publisher products and/or application). In one embodiment, the publisher platform 127 maintains a products data structure 129 that holds data that indicates the products offered by a corresponding publisher. The data structure 129 also constitutes the advertising inventory (e.g., products or applications with advertising space) of the corresponding publishers. In one embodiment, the products may be provided through the service platform 109, the services 111a-111m, and/or the content providers 113a-113m and are thus associated with a publisher. In addition or alternatively, the products may be stored and/or delivered from the data structure 129. In one embodiment, the publisher platform 127 also provides access to analytical reports generated by the advertising platform 101 to publishers/developers. In one embodiment, access to the information on the products data structure 129 is controlled to only privileged services (e.g., the advertising platform 101 and other authorized users). In some embodiments, access is obtained through an API 131.

As shown, the system 100 also includes a merchant/advertiser platform 133 for providing access to the functions of the advertising platform 101 to merchants and other advertisers. For example, the merchant/advertiser platform 133 provides self-service interfaces to enable merchants and/or advertisers to register their listing for location-based results (e.g., a place or point of interest), buy advertisements and search placements, access reporting metrics, etc. In one embodiment, the merchant/advertiser platform 133 maintains an advertisements data structure 135 for storing advertisements, criteria for targeted users, advertising campaigns, coupons, and other related information. In one embodiment, the content information (e.g., media files, graphics, etc.) for the advertisements may be obtained from or provided directly by the service platform 109, the services 111a-111n, and/or the content providers 113a-113m. In one embodiment, the merchant/advertiser platform 133 also provides access to analytical reports generated by the advertising platform 101 to merchants/developers. In one embodiment, access to the information on the advertisements data structure 135 is controlled to only privileged services (e.g., the advertisement enabler 115). In some embodiments, access is obtained through an API 137.

In one embodiment, the merchant/advertiser platform 133 may be used to update the advertisements and related advertising content (e.g., specify new advertisements, target demographics or users, dates of advertisements, etc.). As noted above, the merchant/advertiser platform 133 can present reports as to how an advertising campaign is progressing. The reports may include information as to what the goal of the advertising campaign is (e.g., the target number of unique users or impressions to users present advertisements to associated with the advertising campaign), time period to meet the target, groups of demographics and/or confidence levels associated with those groups, a target rate for meeting the goal over the time period (e.g., a target rate of 100,000 impressions over 10 days would set an expected rate of 10,000 impressions a day), the actual rate at which advertisements are being distributed, etc. Moreover, the merchant/advertiser platform 133 may additionally be utilized to enter input to manually adjust target user criteria or parameters (e.g., based on progress of the advertising campaign). For example, a merchant/advertiser can set or adjust a demographic based on determined click-through-rates associated with advertisements of the campaign presented to users of UEs 103.

By way of example, the communication network 114 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 103 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UE 103 can support any type of interface to the user (such as “wearable” circuitry, etc.).

By way of example, the UE 103 and advertising platform 101 communicate with each other and other components of the communication network 114 using well known, new or still developing protocols. In this context, a protocol includes a set of rules defining how the network nodes within the communication network 114 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the UE 103 (e.g., the advertisement enabler 115), the publisher platform 127, and/or the merchant/advertiser platform 133 interact with the advertising platform 101 according to a client-server model. According to the client-server model, a client process sends a message including a request to a server process, and the server process responds by providing a service (e.g., messaging, advertisements, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

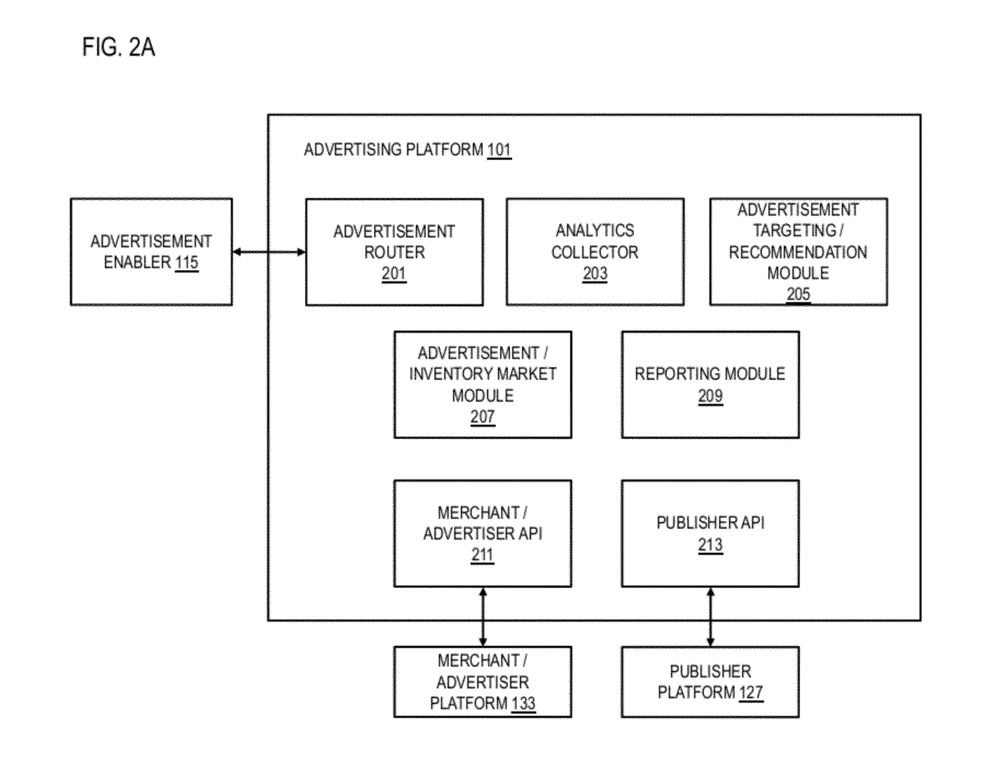

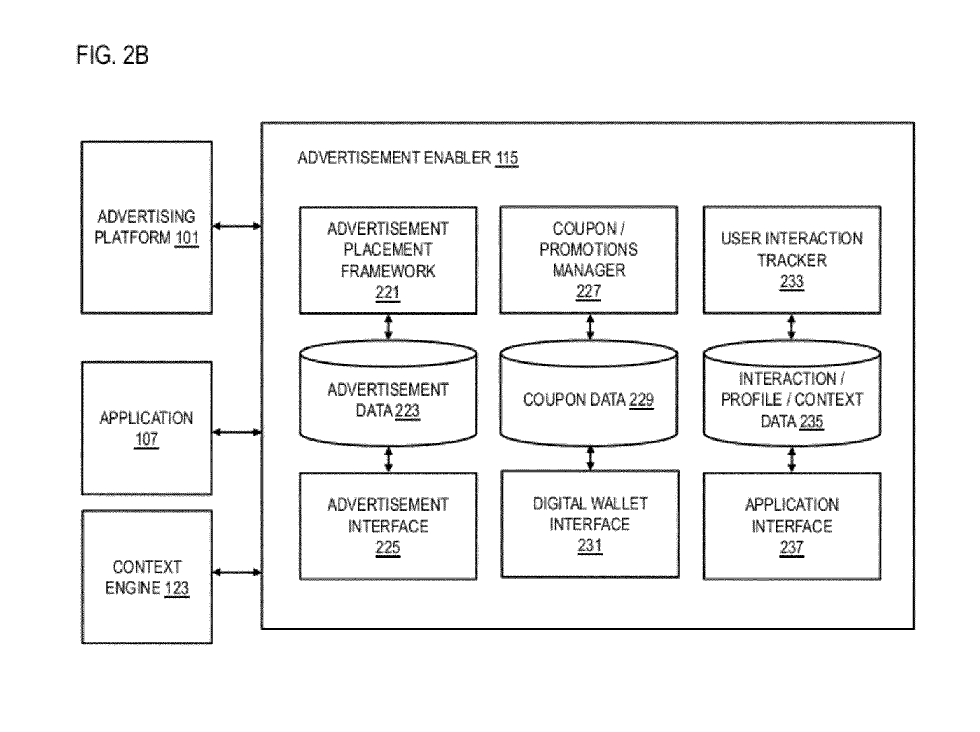

FIG. 2A is a diagram of the components of an advertising platform, according to one embodiment. By way of example, the advertising platform 101 includes one or more components for routing and managing advertisements for presentation to a user, and for performing the functions discussed with respects to the various embodiments described herein. The advertising platform 101 also includes components for reporting advertisement-related use information to, for instance, the publisher platform 127 and/or the merchant/advertiser platform 133. It is contemplated that the functions of these components may be combined in one or more components or performed by other components of equivalent functionality. In this embodiment, the advertising platform 101 includes an advertisement router 201. In one embodiment, the advertisement router 201 processes requests for advertisements from, for instance, one or more advertisement enablers 115 executing in one or more UEs 103. For example, the advertisement router 201 enables routing to and integration with various advertisement providers and networks.

More specifically, the advertisement router 201 feeds advertisement enablers 115 with advertisements from any number of sources (e.g., the merchant/advertiser platform 133, the service platform 109, services 111, online advertisement stores, third party advertisement networks, etc.). In one embodiment, the advertisement router 201 may route advertisement based, at least in part, on context information (e.g., location, time, activity, etc.). In this way, the advertisement router 201 can, for instance, apply country by country or region by region rules and/or polices for presenting advertisements.

In one embodiment, the advertisement router 201 can interact with an analytics collector 203 to track advertisement related transactions (e.g., click through rates, advertisement buys, etc.) for reporting to end users, merchants, advertisers, publishers, and/or other users of the advertising platform 101. These transactions can include, for instance, the costs and payments for placing advertisements, as well as metrics regarding user interactions with the advertisements. For example, if an advertisement includes a coupon or other discount information, the analytics collector 203 can collect information on the redemption of the coupons. In one embodiment, this information can be collected at the UE 103 if it is available. In addition or alternatively, the analytics collector 203 may have an interface or other connectivity to merchant systems (e.g., point-of-sales systems) that can track coupon redemption at both online and offline merchant locations. In one embodiment, the analytics collector 203 can also collect context information, profile information, usage information, and the like from users to facilitate, e.g., targeted advertising, personalization of advertisements, enriching of advertisements, etc.

In one embodiment, the analytics collector 203 can also provide information to the advertisement targeting/recommendation module 205. The targeting/recommendation module 205 can optimize the fulfillment of advertisement requests by, for instance, characterizing the users associated with particular means (e.g., location-based or local searches, applications with in-application advertisement presentation, etc.) and then recommending which advertisements are suited for which means. For example, the targeting/recommendation module 205 can receive criteria (e.g., from merchants/advertisers) for selecting a target audience (e.g., from a merchant or advertiser) and then recommend the means for presenting advertisements to the target audience.

In one embodiment, the targeting/recommendation module 205 can also interact with the advertisement/inventory market module 207 to determine recommended values (e.g., monetary values) for publishers to request from presenting advertisements through their products and for merchant/advertisers to offer to publishers to present advertisements to a target audience. In this way, publishers with products how have high numbers of users or users who are in targeted categories can maximize the value of their inventory of products and applications available for presenting advertisers. Similarly, merchants/advertisers who want to target a specific set of users (e.g., as defined by one or more criteria such as those based on user characteristics, usage history, etc.). In one embodiment, the advertisement/inventory market module 207 can also mediate interactions between merchants/advertisers and publishers by, for instance, matching available inventory against advertisements to present. To facilitate this matching, the advertisement/inventory market module 207 can support a real-time bidding system whereby advertisers can bid or otherwise obtain advertisement placement in publisher products based, at least in part, on the recommended offer and request values generated by the module 207 and/or information from other modules of the advertising platform 101 (e.g., a reporting module 209 as discussed below). In this way, the advertisement/inventory market module 207 optimizes the fulfillment of advertising requests from merchants/advertisers so that their advertisements are presented in publisher products (e.g., applications) that are most likely to yield, for instance, user response and interaction.

As noted, in one embodiment, the advertising platform 101 includes a reporting module 209 for generating reports providing metrics associated with advertisement presentation, user interactions with respect to the advertisements, advertisement effectiveness, yield, and other information generated by, for instance, the other modules of the advertising platform 101. For example, the reports can be based on operation of the any of the components of the advertising platform 101 including the analytics collector 203, the targeting/recommendation module 205, the advertisement market module 207, etc.

In one embodiment, merchants/advertisers access the functions of the advertising platform 101 from the merchant/advertiser platform 133 through the merchant/advertiser API 211. For example, the merchant/advertiser platform 133 can provide a portal (e.g., a web portal or other client) for submitting advertising requests, selecting advertising means, obtaining reports, receiving advertising recommendations, and/or otherwise managing their advertisements and/or their advertising campaigns. In addition or alternatively, it is contemplated that the advertising platform 101 can incorporate all or a portion of the functions of the merchant/advertiser platform 133 for directly interacting with merchants/advertisers.

Similarly, in one embodiment, publishers/developers access the functions of the advertising platform 101 from the publisher platform 127 via the publisher API 213. In this example, the publisher platform 127 can provide a portal for publishers to register products or applications for presenting applications, retrieving advertisements for presentation to users, generating reports, personalizing advertisements based on context, and/or any other functions of the advertising platform 101. In addition or alternatively, it is contemplated that the advertising platform 101 can incorporate all or a portion of the functions of the publisher platform 127 for directly interacting with publishers/developers.

FIG. 2B is a diagram of the components of an advertisement enabler, according to one embodiment. By way of example, the advertisement enabler 115 includes one or more components for receiving and presenting advertisements to a user. It is contemplated that the functions of these components may be combined in one or more components or performed by other components of equivalent functionality. In this embodiment, the advertisement enabler 115 includes an advertisement placement framework 221 and an advertisement data structure 223. By way of example, the advertisement placement framework 221 receives advertising data from, for instance, the advertising platform 101 or other advertisement network available over the communication network 114. The advertising data (e.g., advertisements, information related to how and when to present advertisements, etc.) can then be stored or cached in the advertisement data structure 223.

In other words, the advertisement placement framework 221 serves as the entry and exit points for receiving advertisements and then placing and/or handing off the advertisements to the means for presenting the advertisements (e.g., the application 116, the browser 117) at the UE 103. In one embodiment, the advertisement placement framework includes logic for displaying, converting (e.g., if necessary for presentation via a particular means), etc. the advertisements.

In one embodiment, the advertisement placement framework 221 can also relay context and/or profile information to advertising platform 101 to facilitate enriching of the advertisements with personalized or other custom information. In this way, the advertisements can be more specifically targeted and/or tailored to individual characteristics and/or preferences of a user.

As shown, the advertisement framework 221 has connectivity to components external to the advertisement enabler 115 via the advertisement interface 225. For example, the advertisement interface facilitates communications between the advertisement interface 225 and one or more of the advertising platform 101, the application 107, the browser 117, and/or other like components. In one embodiment, the advertisement interface 225 exposes its interface via standard APIs (e.g., Qt, Web Runtime (WRT), Java, etc.).

In some embodiments, the advertisements or advertising data include one or more coupons, discount information, promotions, offers, and other marketing information. Accordingly, the advertisement enabler 115 includes a coupon/promotions manager 227 that can parse the coupon and other similar information from the advertisements for storage in the coupon data structure 229. In this way, the coupon, promotion, discount, etc. is available for immediate use by the user. In one embodiment, the coupon/promotions manager 227 can also interact with a digital wallet interface 231 to enable storing of the coupon or other discount in formation in a digital wallet or other storage external to the advertisement enabler 115. As with the advertisement interface 225, the digital wallet interface 231 can be exposed using standard APIs (e.g., Qt, WRT, Java, etc.).

In one embodiment, the advertisement enabler 115 includes a user interaction tracker 233 for collecting, for instance, user interactions and/or responses to a presentation of the advertisements served through advertisement enabler 115. By way of example, the user interaction may include determining click through rates, conversion rates, etc. to facilitate determination of the effectiveness of the advertisements. In some embodiments, the user interaction tracker 233 may perform more sophisticated monitoring of user interactions such as tracking application use, coupon use, states changes, etc. associated with the UE 103, the applications or processes executing at the UE 103, or a combination thereof. In one embodiment, the user interaction tracker 233 can also monitor context changes, profile information, etc. associated with the UE 103 or a user associated with the UE 103 to, for instance, facilitate the customization and/or personalization of advertisements.

In one embodiment, the information collected by the user interaction tracker 233 is stored in the interaction/profile/context data structure 235. In addition, the user interaction tracker can operate via the application interface 237 to retrieve interaction information from one or more applications (e.g., application 107, browser 117) executing at the UE 103. The application interface 237 can also provide connectivity to the context engine 123 of the UE 103 to directly determine context information via, for instance, one or more sensors or sources of context information available at the UE 103.

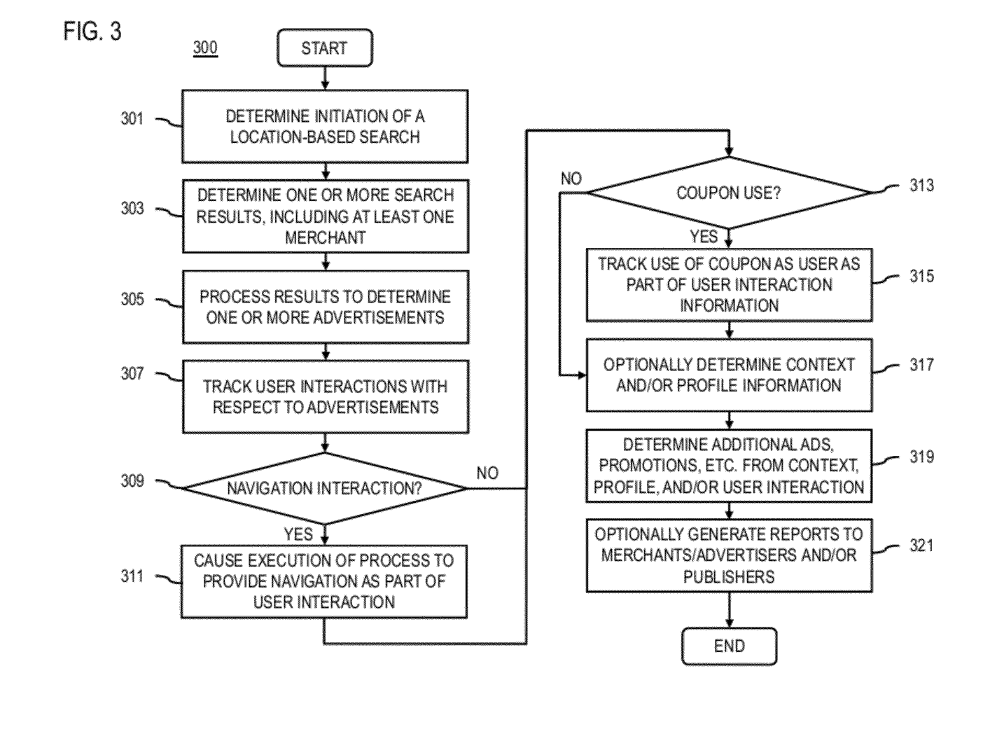

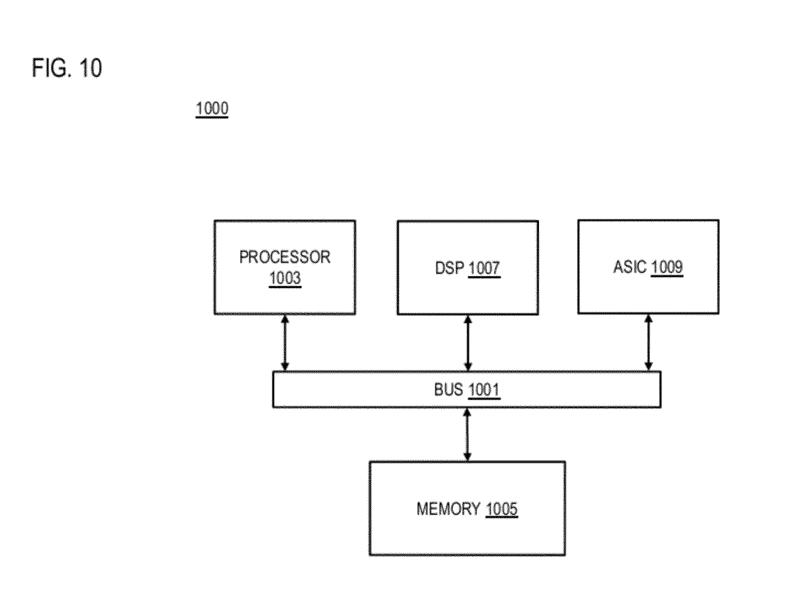

FIG. 3 is a flowchart of providing advertisements to a location-based search via the advertising platform, according to one embodiment. In one embodiment, the advertising platform 101 performs the process 300 and is implemented in, for instance, a chip set including a processor and a memory as shown FIG. 10. In addition or alternatively, all or a portion of the process 300 can be performed by the advertisement enabler 115, the merchant/advertiser platform 133, the publisher 127, or a combination thereof.

In step 301, the advertising platform 101 determines an initiation of a location-based search at a device. As noted above, a location-based search is search for local information that is within a certain proximity of the UE 103 or a location specified by the UE 103. By way of example, in one embodiment, the location-based or local search can be requested in a user interface specified at the device. The user interaction tracker 233 of the advertisement enabler 115 can then inform the advertising platform 101 of the request.

In step 303, the advertising platform 101 then determines one or more results of the location-based search, the one or more results including at least one listing for at least one merchant or advertiser (e.g., a merchant/advertiser registered through the merchant/advertiser platform 133 to present advertisements to the user). In one embodiment, the advertising platform 101 need not itself generate the search results. For example, the advertising platform 101 can act on search results generated by a search engine or other components of the UE 103 and/or the communication network 114 (e.g., the service platform 109 or services 111).

Next, the advertising platform 101 processes and/or facilitates a processing of the one or more results to determine one or more advertisements associated with the at least one merchant for presentation at the device (step 305). For example, determining the advertisements may include querying one or more advertisements stores or networks for advertisements associated with the merchant. In one embodiment, the advertisement may take the form of elevating a particular merchant listing in the list or order of the search results, so that the listing can be displayed more prominently or in a more prominent location. Other forms of advertisements include banner advertisements, advertisements linked to specific locations or places, event or situational advertisements that are contingent on specific events or contexts to trigger, and/or any other form of advertisement. In one embodiment, the local search results can be coordinated with results obtained from more general searches such as a web search, media search, music search, application store search, device search, or other real-time or substantially real-time searches.

The advertising platform 101 then causes, at least in part, tracking of user interaction information in response to the presentation of the one or more advertisements (step 307). In one embodiment, it is contemplated that the one or more results, the at least one merchant, the one or more advertisements, the user interaction, or a combination thereof relate, at least in part, to online commerce, offline commerce, or a combination thereof. More specifically, the advertising platform can determine whether the user takes any action in response to the presentation of the advertisement. For example, the advertising platform 101 can track whether the user has clicked on the advertisement or made a purchase in response to the advertisement. In one embodiment, the advertisement may include additional interactions such invoking related applications and/or functions. Accordingly, in one embodiment, the advertising platform 101 determines whether the advertisement is associated with at least a navigation interaction (step 309). If there is navigation interaction, the advertising platform 101 causes, at least in part, execution of at least one process to provide a navigation, a mapping, or a combination thereof of the one or more results (e.g., the result corresponding to merchant/advertiser) (step 311). In this case, the user interaction being tracked includes, at least in part, one or more interactions with respect to the navigation, the mapping, or a combination thereof.

The advertising platform 101 can also determine whether the advertisements are associated with at least one coupon or other discount information (step 313). If at least one coupon is included, the advertising platform 101 causes, at least in part, tracking of use information associated with the at least one coupon (step 315). By way of example, the at least one coupon is a physical coupon, a digital coupon, or a combination thereof. If the coupon is a physical coupon or related to a physical or offline merchant, the advertising platform 101 can track the use of the coupon through a redemption network including, for instance, point-of-sales systems used by the offline merchant. If the coupon is related to an online merchant, coupon transactions related to the online merchant can also be tracked through the merchant's sales or redemption systems.

In one embodiment, the advertising platform 101 can optionally determine profile information, context information, or a combination thereof associated with the device, a user of the device, or a combination thereof (step 317). The advertising platform 101 can then process and/or facilitate a processing of the profile information, the context information, or a combination thereof to determine one or more other advertisements, one or more promotions, one or more products, or a combination thereof for presentation at the device (step 319). In this way, the advertising platform 101 provides for continuous interaction with the UE 103 to provide for presentation and tracking of related advertisements and tailor the advertising experience to the continuing actions taken by the user.

In step 321, the advertising platform 101 optionally generates reports regarding metrics associated with, for instance, presentation of the advertisement, effectiveness of the advertisements (e.g., click through rates, conversion rates), use interaction information, user characteristics and/or demographics, and other information collected and/or used by the advertising platform 101 or other components of the system 100 for managing advertisements and/or advertisement campaigns.

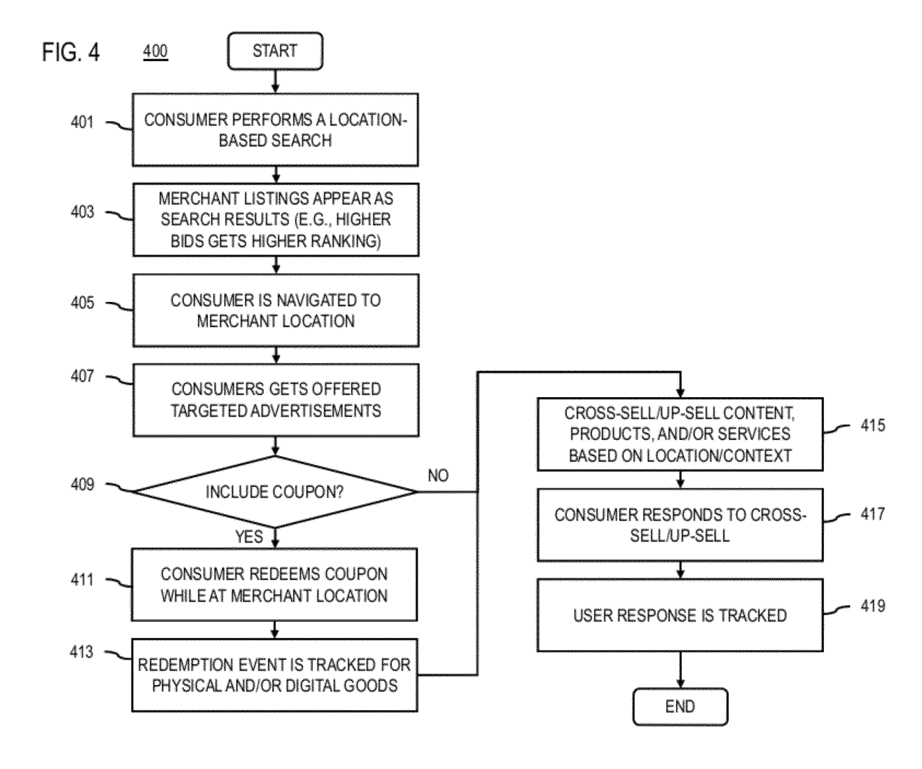

FIG. 4 is a flowchart of a sample use case for providing advertisements to a location-based search, according to one embodiment. The process 400 of FIG. 4 provides an example consumer experience process flow that enables online, mobile consumers to connect with merchants and/advertisers (e.g., including offline merchants). In step 401, the consumer performs a location-based search (e.g., a local search) for nearby places or point-of-interests. The consumer is then presented with a listing of merchants that can appear, for instance, on a local map such that listings of merchants bidding higher amounts (e.g., for advertisement placement) get higher ranking scores in search results (step 403).

The consumer can then select at least one of the listings to be navigated to the place associated with the listing (e.g., typically a merchant location or store) (step 405). As part of this interaction, the user can be offered targeted advertisements based, at least in part, on the location or place to which the consumer is being navigated (step 407). In one embodiment, the advertisement may also include coupons (step 409). If the advertisement includes a coupon, the consumer can save the coupon in, for instance, the consumer's digital wallet and/or can decide to redeem the coupon right away at the merchant location (e.g., via the merchant's point-of-sales system) to obtain physical goods (step 411). For digital goods, the consumer can redeem the coupon when requesting a download of the physical goods from an online store (e.g., an online application store). In either case, the redemption event can be tracked for both the physical and/or digital goods for reporting back to the merchants or publishers of the goods (step 413).

In one embodiment, the system 100 enables cross-selling and/or up-selling of content, products, services, etc. that might be relevant to the consumer's location, profile information (e.g., demographics, preferences), and other context information (e.g., activity, time, etc.) (step 415). More specifically, based on the consumer profile and other analytical information about the consumer (e.g., download history, location history, purchase history, coupon redemption history, etc.), the system 100 can determine whether the user is or has been previously affiliated with the merchant or other merchants. The consumer can then be presented with related offers in the form of additional advertisements (e.g., in-application advertisements). For example, the in-application advertisements or the application serving the advertisements can exploit context-aware interfaces affect, for instance, how, when, what, etc. advertisements are presented based, at least in part, on the context of user situation, needs, friend network recommendations, location search results, click history, etc.).

The consumer can then respond to the cross-sell/up-sell advertisements (step 417), which, in turn, can trigger other related advertisements based on the user's continued interaction. As previously, described the user interactions can be tracked (step 419) for reporting to merchants/advertisers, publishers, and other entities involved in the advertising process.

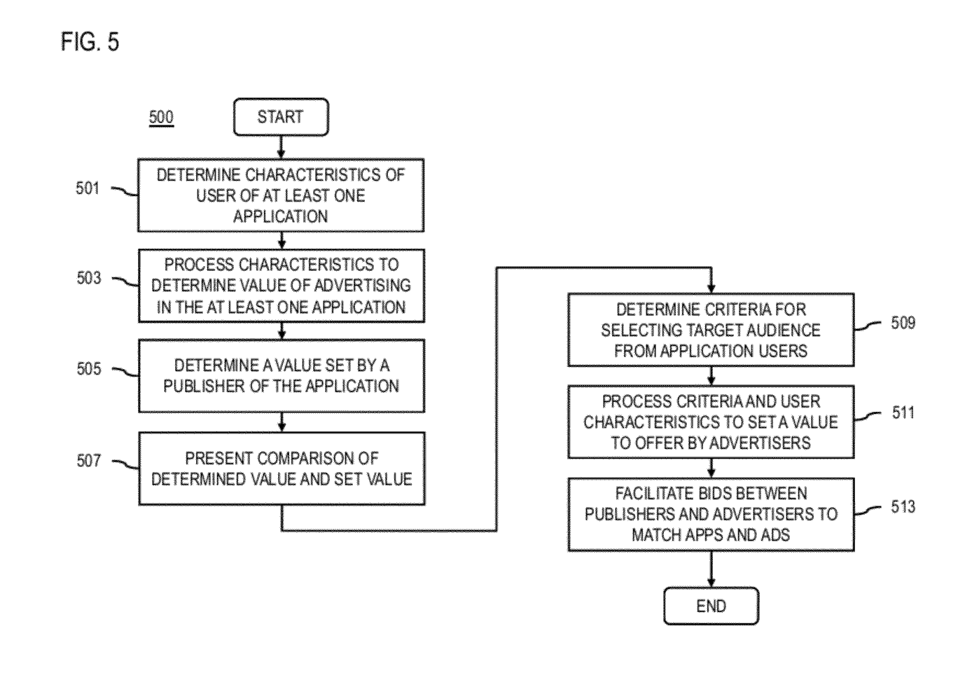

FIG. 5 is a flowchart of a process for managing advertisements and inventory for presenting the advertisements, according to one embodiment. In one embodiment, the advertising platform 101 performs the process 500 and is implemented in, for instance, a chip set including a processor and a memory as shown FIG. 10. In addition or alternatively, all or a portion of the process 300 can be performed by the advertisement enabler 115, the merchant/advertiser platform 133, the publisher 127, or a combination thereof. As noted above, the amount of advertisements and the inventory of means (e.g., applications) for presenting the advertisements are generally unbalanced. Accordingly, the process 500 enables the advertising platform 101 to facilitate mediation between merchants/advertisers who generate advertisements and publishers/developers who provide the products for presenting the advertisements. In one embodiment, this mediation includes bi-directional price setting and bidding for advertisements as described below. In this way, successful publishers (e.g., publishers whose products are popular with coveted target audiences) can increase their inventory value while enabling merchants/advertisers to acquire a target audience at a particular price or value.

From the inventory side (e.g., the publisher/developer side), in step 501, the advertising platform 101 determines user characteristic information associated with a plurality of users of at least one application. By way of example, the user characteristic information includes, at least in part, an age group, a gender, a usage history of the at least one application, other demographic information, or a combination thereof. In one embodiment, the information can be presented as a chart or table presenting each monitored user characteristic. Next, the advertising platform 101 processes and/or facilitates a processing of the user characteristic information to determine at least one recommended value to request for presenting one or more advertisements via the at least one application (step 503). By way of example, the recommended value can be a monetary value that the publisher can charge to advertisers for presenting advertisements. In one embodiment, the recommended value is also based on market conditions (e.g., how many advertisements, whether user characteristics are targeted by advertisers, etc.). In other words, recommended value can represent the estimated market value of a publisher's inventory with respect to advertising.

In one embodiment, the advertising platform 101 can also determine a set value for presenting the one or more advertisements via the least one application, wherein the set value is determined by a publisher of the at least one application (step 505). For example, the publisher is free to set a value the publisher thinks that the inventory is worth apart from the recommended value generated above. The advertising platform 101 can then cause, at least in part, presentation of a comparison of the at least one recommended value to request against the set value (step 507). In this way, the advertising platform 101 can give an indication to the publisher whether the set value is above or below the recommended market value of the inventory. The publisher is then free to adjust the set value or to proceed with the set value regardless of the recommended value.

From the merchant/advertiser side, in one embodiment, the advertising platform 101 determines one or more criteria for selecting at least one target audience for the one or more advertisements, the target audience comprising, at least in part, one or more users of the at least one application (step 509). In one embodiment, the advertising platform 101 can determine what parameters and/or criteria to present to the merchant/advertiser for selection. For example, the advertising platform 101 analyzes available analytical data about the users of a variety of applications to determine which criteria or parameter of the user characteristics can most affect the effectiveness of advertisements. For example, the criteria may relate to an age group, gender, application usage, and/or any other demographic or profile parameter.

In one embodiment, the advertising platform 101 processes and/or facilitates a processing of the one or more criteria and the user characteristic information to determine at least one other recommended value to offer by at least one advertiser for presenting the one or more advertisements via the least one application (step 511). This recommended value, for instance, represents a recommended value for the merchant/advertiser to offer to a publisher for presenting the advertisement. As with the recommended value for publishers, the merchant/advertiser is free to set an offer value. For example, the merchant/advertiser can set how many clicks to buy as well as the highest cost per click (CPC) that the merchant/advertiser is willing to pay.

Based on the set request values from one or more publishers and the set offer value from the merchant/advertisers, the advertising platform 101 can recommend to publishers which advertisers are making the best offers, and to the merchants/advertisers which publishers are offering the users that most closely match target criteria and/or offer the optimum price and/or value for a given advertising campaign. In one embodiment, the advertising platform 101 may provide the matching as part of a bi-directional bidding process between publishers/developers and merchants/advertisers.

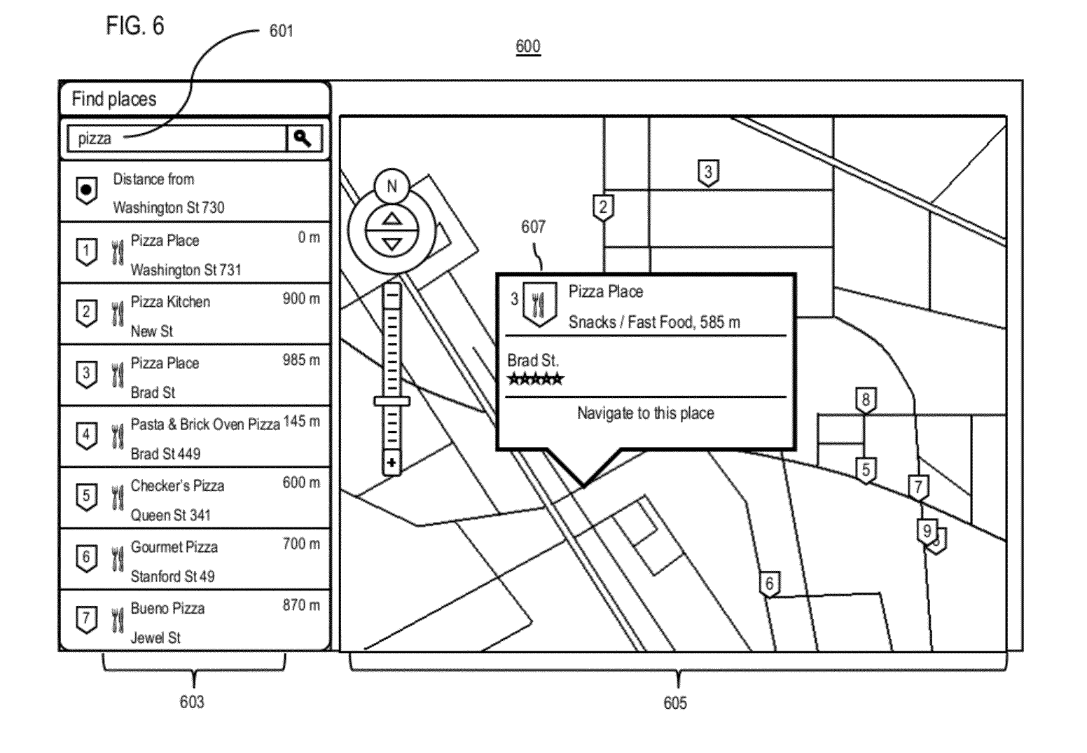

FIG. 6 is a diagram of a user interface for location-based targeted advertising, according to one embodiment. In this example, an advertising service is provided whereby paid listings do show explicit advertisements, but, instead, merchants/advertisers pay to influence their rank in a search algorithm as a form of advertisement. By way of example, merchants/advertisers advertising in this way can select, for instance, search keywords that will make their locations or listings detectable via a location-based or local search. In one embodiment may pay an extra advertising fee to “boost” their listings in the search results.

As shown in FIG. 6, a map interface 600 is presented in response to search based on a keyword 601 that is specified as “pizza.” In this example, all merchants who entered “pizza” as a keyword would be displayed in the column 603 in order by proximity to the user conducting the search. This represents, for instance, a neutral result where no results are boosted.

In one embodiment, in the right portion 605 of the map interface 600, one result (e.g., the result for listing 3 in column 603 is give a higher preference based, at least in part, on the merchant paying advertising fees to boost the merchant's visibility. As a result, a separate place container 607 is presented in the right portion 605 to represent the boosted listing 3 and provide more visibility as a form of advertisement. In one embodiment, the place container 607 can be selected to navigate the user to the place where additional advertisements (e.g., coupons, discounts, etc.) can be presented to the user.

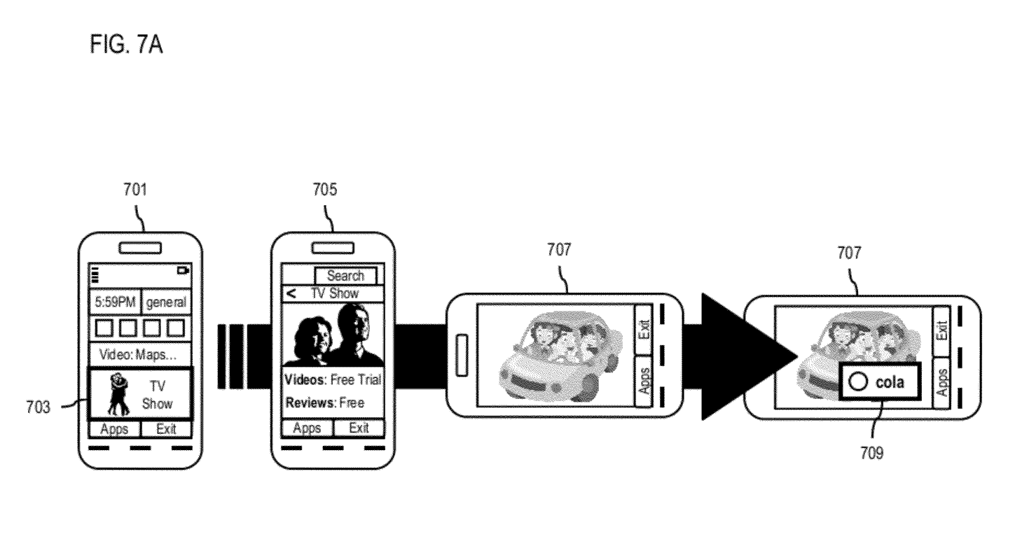

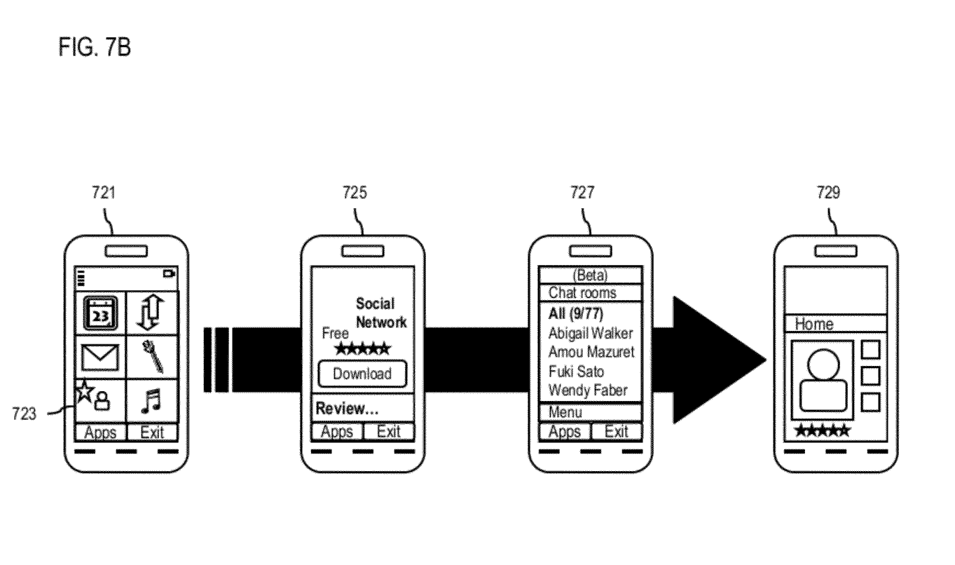

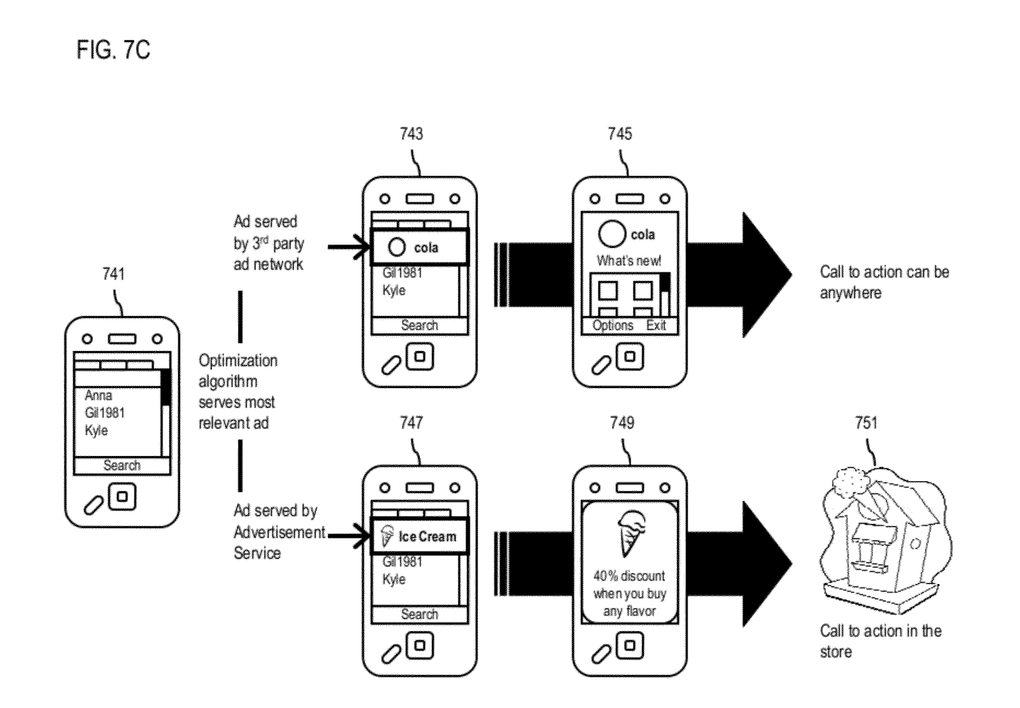

FIGS. 7A-7C are diagrams of user interfaces for targeted advertising based on user interaction, according to various embodiments. The user interfaces of FIGS. 7A-7C represent a sample use case of using advertisements in response to user interactions to promote discovery and consumption of content. As shown in FIG. 7A, a user interface (UI) 701 depicts an example home screen of a mobile device. In this case, the device manufacturer has provided a space 703 for presenting advertisements on the home screen. For example, the UI 701 requests an advertisement from the advertising platform 101 for presentation in the space 703. In this example, an advertisement for a television show is presented in the space 703.

The advertisement in the space 703 points to an online content store from which the user can download and/or purchase a video of the television show. The advertising platform 101 can track user interaction with respect to the advertisement. For example, if the user clicks on the space 703, the advertising platform 101 can direct the user to an online content store. The UI 705 represents the video download screen of the content store. The user downloads the video from the store and begins watching the video in UI 707.

The advertising platform 101 continues to track the user behavior (e.g., downloading and watching the video) and continues to present relevant or appropriate advertisements. In this case, depending on, for instance, advertising relationships, user context information, user profile information, etc., the advertising platform 101 can cause presentation of an advertisement within UI 707 as the user continues to watch the video. For example, if the video at that point is related to the advertisement 709, the advertising platform 101 triggers the display of the advertisement 709. In this way, the sequence of UIs 701, 705, and 707 of FIG. 6 illustrates a process whereby the advertising platform 101 tailors the presentation of advertisements based on user interaction with the initial advertisement 703 in the UE 701.

FIG. 7B depicts another example of content discovery through advertisements, according to one embodiment. In this example, the UI 721 depicts an application menu of an example UE 103. The UI 721 lists applications that have already been installed as well as an advertisement 723 for an application recommended to the user. By way of example, the advertisement 723 is differentiated from the other installed application by a star. It is also contemplated that any other representation (e.g., graphical representation such as color, icon, size, etc.) can be used to distinguish the advertisement 723. In this example, the advertisement 723 is for a social networking application.

If the user clicks on the advertisement 723, the advertising platform 101 causes, at least in part, a presentation of the of a UI 725 depicting the front-end of an application store where the user can download a free trial of the social networking application. The user downloads and begins using the application as shown in UE 727. The advertising platform 101 tracks this user interaction, and as the free version of the social networking application is being used, the advertising platform 101 can present an advertisement in the UI 729 to up-sell the user to buy a premium version of the social networking application.

FIG. 7C depicts an example of tailoring in-application advertisements based on context information, according to one embodiment. In this example, a consumer is using a messaging application with a UE 721. The messaging application is capable of serving in-application advertisements to the user using, for instance, an optimization algorithm that can serve the most relevant advertisement based, at least in part, on the user's context or the context of the user's device (e.g., a UE 103). For example, if the advertising platform 101 determines that the user is not near any of the locations associated with potential advertisers, the advertising platform 101 can present advertisements in a traditional fashion. In this case, the advertising platform 101 selects an advertisement from a third party advertisement network and presents the advertisement with the messaging application as shown in the UI 743. The user clicks on the advertisement and is presented with a web page about the product in the UI 745. The UI 745 may include a call to action with respect to any designated place because the user is not near a location of the advertiser. For example, this call to action might be to navigate to the place, use a coupon at the place, or any other action designated by the advertiser.

However, if the user or UE 103 is near a location associated with an advertiser, the advertising platform 101 may select an advertisement associated with a location near the UE 103. In this case, as shown in UI 747, the advertising platform 101 causes, at least in part, presentation of an advertisement for a nearby ice cream shop. On clicking on the advertisement in the UI 747, the advertising platform 101 causes, at least in part, presentation of a coupon that can be used immediately by the consumer as shown in 749. The user is then directed to the ice cream shop 751 where the coupon can be redeemed. In this way, the advertising platform 101 facilitates interaction between online UEs 103 and offline merchants (e.g., the ice cream shop 751).

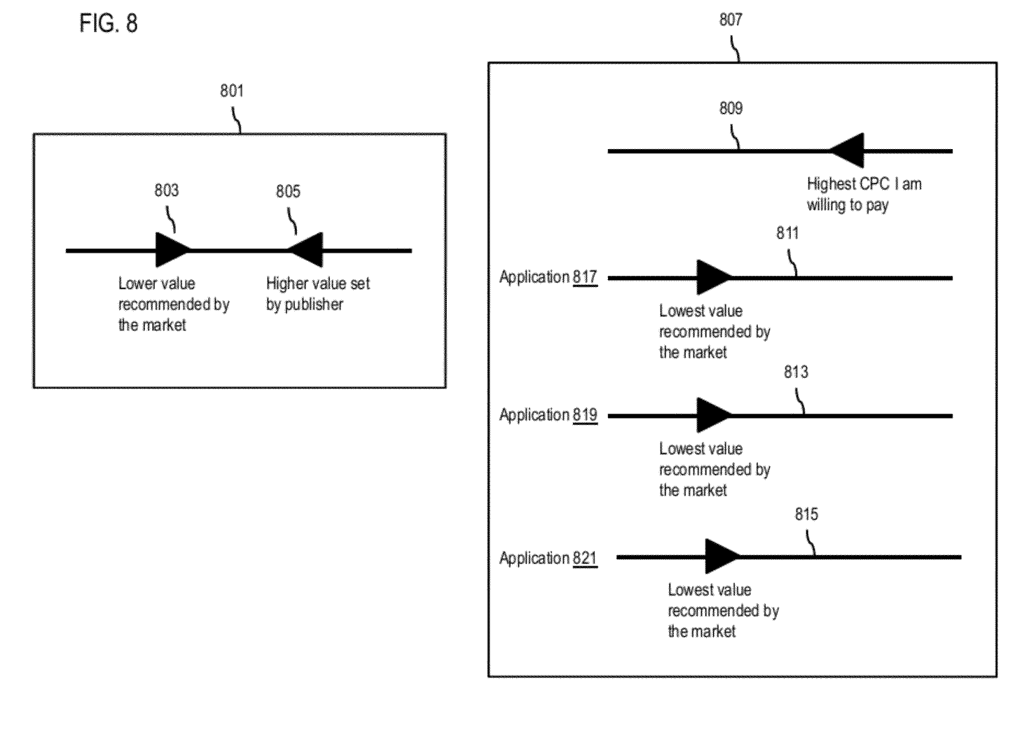

FIG. 8 is a diagram of user interfaces for managing advertisements and inventory for presenting the advertisements, according to one embodiment. More specifically, FIG. 8 depicts users interfaces for mediating advertisement transactions between merchants/advertisers (e.g., providers of advertisements) and publishers (e.g., providers of inventory for presenting advertisements) as described with respect to the process 500 of FIG. 5. As shown, a UI 801 represents an example user interface for publishers to view and compare recommended request for comparison against set request values for requested from advertisers to present advertisements. In this example, the recommended value and set value are depicted as arrows 803 and 805 respectively on a line representing a relative value scale. The relative positions of the arrows 803 and 805 indicate that the publisher has set a value to request that is higher than the value recommended by the advertising platform 101 based, at least in part, on its collected analytics. The publisher can, for instance, chose to move the arrow 805 representing the set value closer to the arrow 803 representing the recommended value. Accordingly, as the arrow 805 is dragged and moved the corresponding set value is increased or decreased.

The UI 807 of FIG. 8 represents values that can be a merchant/advertiser to select potentially matching applications for display of advertisements. As shown, the UI 807 includes a slider 809 that is set by the merchant/advertiser to indicate the high offer (e.g., as a CPC) that the merchant/advertiser is willing to pay for presenting an advertisement. In response, the advertising platform 101 presents sliders 811-815 corresponding to, for instance, applications 817-821 respectively. The sliders 811-815 represent the lowest value recommended by the market for the presenting advertisements in the respective applications 817-821. The lowest recommended values for the applications 817-821 are matched against the highest value specified by the merchant/advertiser to generate the list. In one embodiment, the merchant/advertiser can move the slider 809 to indicate a different high value to offer, which can result in a different list of applications being presented in UI 807.

In one embodiment, the both the publishers (e.g., on the inventory side) and the merchants (e.g., on the advertisement side) can manipulate their respective sliders to indicate respective bids in a bi-directional bidding process mediated by the advertising platform 101.

The processes described herein for providing an advertising platform may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

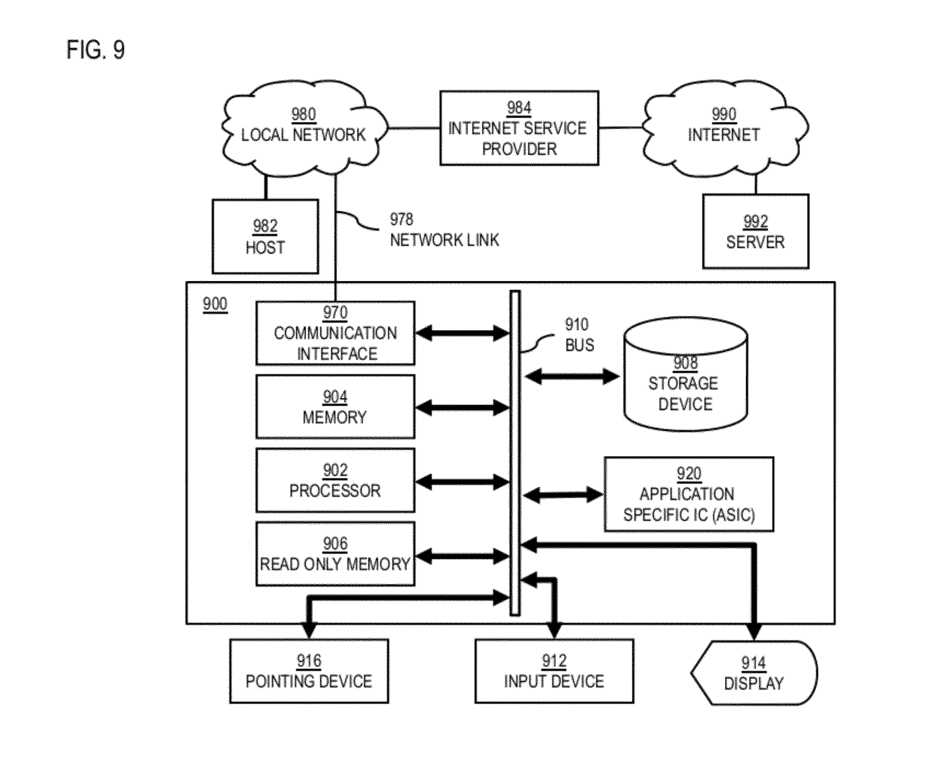

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to provide an advertising platform as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of providing an advertising platform.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to providing an advertising platform. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for providing an advertising platform. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing an advertising platform, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 114 for providing an advertising platform.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to provide an advertising platform as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of providing an advertising platform.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide an advertising platform. The memory 1005 also stores the data associated with or generated by the execution of the inventive steps.

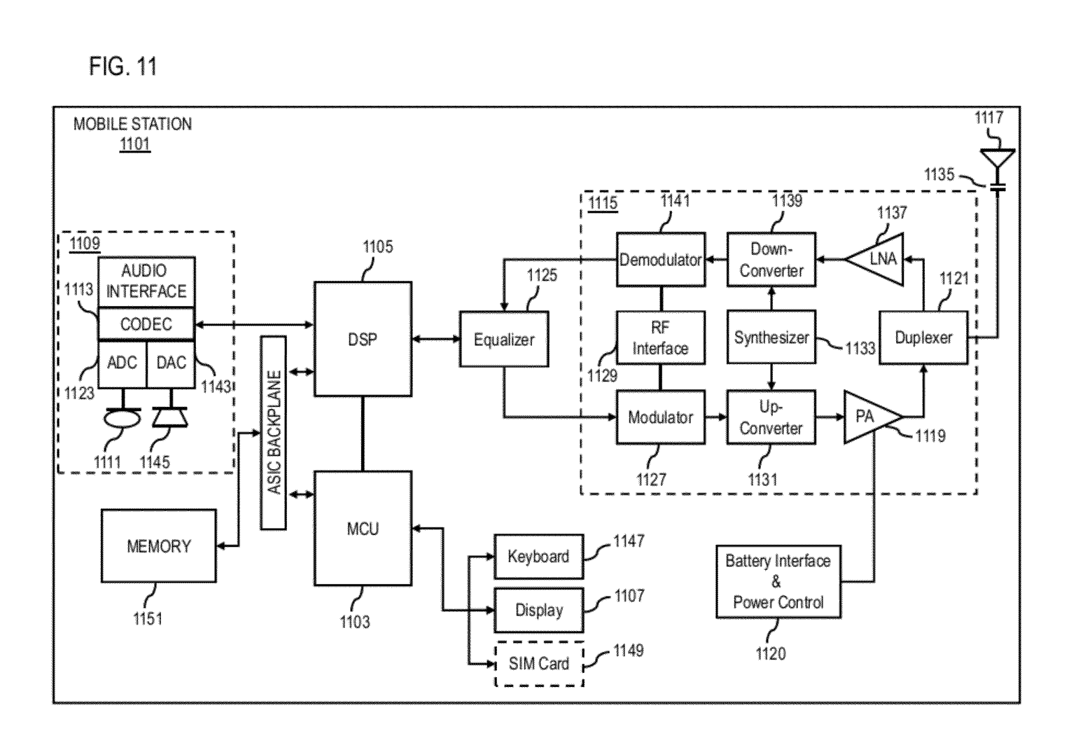

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of providing an advertising platform. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of providing an advertising platform. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to provide an advertising platform. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
an initiation of a location-based search at a device;
one or more results of the location-based search, the one or more results including at least one listing for at least one merchant;
a processing of the one or more results to determine one or more advertisements associated with the at least one merchant for presentation at the device; and
a tracking of user interaction information in response to the presentation of the one or more advertisements.

2. A method of claim 1, wherein the (1) data and/or (2) information and/or (3) at least one signal are further based, at least in part, on the following:
a processing of the user interaction information to determine one or more other advertisements, one or more promotions, one or more products, or a combination thereof for presentation at the device.

3. A method of claim 1, wherein the (1) data and/or (2) information and/or (3) at least one signal are further based, at least in part, on the following:
an execution of at least one process to provide a navigation, a mapping, or a combination thereof of the one or more results,
wherein the user interaction includes, at least in part, one or more interactions with respect to the navigation, the mapping, or a combination thereof.

4. A method of claim 1, wherein the one or more advertisements include or are associated with at least one coupon, and wherein the (1) data and/or (2) information and/or (3) at least one signal are further based, at least in part, on the following:
a tracking of use information associated with the at least one coupon,
wherein the at least one coupon is a physical coupon, a digital coupon, or a combination thereof.

5. A method of claim 1, wherein the (1) data and/or (2) information and/or (3) at least one signal are further based, at least in part, on the following:
profile information, context information, or a combination thereof associated with the device, a user of the device, or a combination thereof;
a processing of the profile information, the context information, or a combination thereof to determine one or more other advertisements, one or more promotions, one or more products, or a combination thereof for presentation at the device.

6. A method of claim 1, wherein the one or more results, the at least one merchant, the one or more advertisements, the user interaction, or a combination thereof relate, at least in part, to online commerce, offline commerce, or a combination thereof.

7. A method comprising facilitating a processing of and/or processing (1) data and/or (2) information and/or (3) at least one signal, the (1) data and/or (2) information and/or (3) at least one signal based, at least in part, on the following:
user characteristic information associated with a plurality of users of at least one application; and
a processing of the user characteristic information to determine at least one recommended value to request for presenting one or more advertisements via the at least one application.

8. A method of claim 7, wherein the (1) data and/or (2) information and/or (3) at least one signal are further based, at least in part, on the following:
a set value for presenting the one or more advertisements via the least one application, wherein the set value is determined by a publisher of the at least one application; and
a presentation of a comparison of the at least one recommended value to request against the set value.

9. A method of claim 7, wherein the (1) data and/or (2) information and/or (3) at least one signal are further based, at least in part, on the following:
one or more criteria for selecting at least one target audience for the one or more advertisements, the target audience comprising, at least in part, one or more users of the at least one application; and
a processing of the one or more criteria and the user characteristic information to determine at least one other recommended value to offer by at least one advertiser for presenting the one or more advertisements via the least one application.

10. A method of claim 7, wherein the user characteristic information includes, at least in part, an age group, a gender, a usage history of the at least one application, other demographic information, or a combination thereof.

11. An apparatus comprising:
at least one processor; and
at least one memory including computer program code for one or more programs,
the at least one memory and the computer program code configured to, with the at least one processor, cause the apparatus to perform at least the following,
determine an initiation of a location-based search at a device;
determine one or more results of the location-based search, the one or more results including at least one listing for at least one merchant;
process and/or facilitate a processing of the one or more results to determine one or more advertisements associated with the at least one merchant for presentation at the device; and
cause, at least in part, tracking of user interaction information in response to the presentation of the one or more advertisements.

12. An apparatus of claim 11, wherein the apparatus is further caused to:
process and/or facilitate a processing of the user interaction information to determine one or more other advertisements, one or more promotions, one or more products, or a combination thereof for presentation at the device.

13. An apparatus of claim 11, wherein the apparatus is further caused to:
cause, at least in part, execution of at least one process to provide a navigation, a mapping, or a combination thereof of the one or more results,
wherein the user interaction includes, at least in part, one or more interactions with respect to the navigation, the mapping, or a combination thereof.

14. An apparatus of claim 11, wherein the one or more advertisements include or are associated with at least one coupon, the method further comprising:
cause, at least in part, tracking of use information associated with the at least one coupon,
wherein the at least one coupon is a physical coupon, a digital coupon, or a combination thereof.

15. An apparatus of claim 11, wherein the apparatus is further caused to:
determine profile information, context information, or a combination thereof associated with the device, a user of the device, or a combination thereof;
process and/or facilitate a processing of the profile information, the context information, or a combination thereof to determine one or more other advertisements, one or more promotions, one or more products, or a combination thereof for presentation at the device.

16. An apparatus of claim 11, wherein the one or more results, the at least one merchant, the one or more advertisements, the user interaction, or a combination thereof relate, at least in part, to online commerce, offline commerce, or a combination thereof.

17. An apparatus comprising:
at least one processor; and
at least one memory including computer program code for one or more programs,
the at least one memory and the computer program code configured to, with the at least one processor, cause the apparatus to perform at least the following,
determine user characteristic information associated with a plurality of users of at least one application; and
process and/or facilitate a processing of the user characteristic information to determine at least one recommended value to request for presenting one or more advertisements via the at least one application.

18. An apparatus of claim 17, wherein the apparatus is further caused to:
determine a set value for presenting the one or more advertisements via the least one application, wherein the set value is determined by a publisher of the at least one application; and
cause, at least in part, presentation of a comparison of the at least one recommended value to request against the set value.

19. An apparatus of claim 17, wherein the apparatus is further caused to:
determine one or more criteria for selecting at least one target audience for the one or more advertisements, the target audience comprising, at least in part, one or more users of the at least one application; and
process and/or facilitate a processing of the one or more criteria and the user characteristic information to determine at least one other recommended value to offer by at least one advertiser for presenting the one or more advertisements via the least one application.

20. An apparatus of claim 17, wherein the user characteristic information includes, at least in part, an age group, a gender, a usage history of the at least one application, other demographic information, or a combination thereof.
